(19) United States
(12) Patent Application Publication
(10) Pub. No.: US 2016/0072799 A1
(43) Pub. Date: Mar. 10, 2016

(54) Method And System For Achieving Screen Unlocking Of A Mobile Terminal Through Retina Information Matching

(71) Applicant: HUIZHOU TCL MOBILE COMMUNICATION CO., LTD, Guangdong (CN)

(72) Inventor: Binghui HU, Huizhou City, Guangdong (CN)

(73) Assignee: HUIZHOU TCL MOBILE COMMUNICATION CO., LTD., Huizhou City, Guangdong (CN)

(21) Appl. No.: 14/786,390

(22) PCT Filed: Jun. 4, 2014
(86) PCT No.: PCT/CN2014/079132

§ 371 Date: Oct. 22, 2015

(30) Foreign Application Priority Data
Apr. 14, 2014 (CN) 201410147312.5

(51) Int. Cl. H04L 29/06; H04M 1/725; H04M 1/67; G06K 9/00; H04W 12/06

(52) U.S. Cl. CPC H04L 63/0861; G06K 9/00604; G06K 9/00617; G06K 9/0061; H04W 12/06; H04L 63/0853; H04M 1/67; H04M 1/7253

(57) ABSTRACT

A method and a system for achieving screen unlocking of a mobile terminal through retina information matching are disclosed. The method comprises: storing first retina information for screen unlocking into the mobile terminal; communicatively connecting a retina reading device with the mobile terminal; reading second retina information and transmitting the second retina information to the mobile terminal by the retina reading device; receiving the second retina information and matching the second retina information against the first retina information by the mobile terminal; and if the second retina information matches the first retina information, then generating a screen unlocking instruction to unlock the screen of the mobile terminal.

### FIELD OF THE INVENTION

The present disclosure generally relates to screen unlocking of a mobile terminal, and more particularly, to a method and a system for achieving screen unlocking of a mobile terminal through retina information matching.

### BACKGROUND OF THE INVENTION

As mobile terminals become more and more popular, people's lives have been more closely related to the mobile terminals. It is inconvenient to unlock a mobile phone through sliding movement on the touch area or by inputting a password, especially at the work that requires a high efficiency.

However, wearable devices have found application in people's lives and provide more diversified applications for users. Besides, the wearable devices bring about more conveniences to the numerous consumers and improve the living quality of the people.

If the screen of a mobile terminal can be unlocked through device cooperation and information matching when the user is using the wearable device, e.g., if the mobile terminal can be unlocked automatically when the mobile terminal is put at 30 cm right in front of the user, then it will make the operation very convenient for the user. However, this technology is not yet available in the real life.

Accordingly, there is still a need to make improvements and advancements on the conventional technologies.

### SUMMARY OF THE INVENTION

In view of the aforesaid shortcomings of the prior art, an objective of the present disclosure is to provide a method and a system for achieving screen unlocking of a mobile terminal through retina information matching, which can rapidly and conveniently unlock the screen of the mobile terminal through device cooperation and information matching.

To achieve the aforesaid objective, technical solutions adopted by the present disclosure are as follows.

A method for achieving screen unlocking of a mobile terminal through retina information matching is provided, which comprises the following steps of:

A. storing first retina information for screen unlocking into the mobile terminal;

B. communicatively connecting a retina reading device with the mobile terminal;

C. reading second retina information and transmitting the second retina information to the mobile terminal by the retina reading device;

D. receiving the second retina information and matching the second retina information against the first retina information by the mobile terminal; and

E. if the second retina information matches the first retina information, then generating a screen unlocking instruction to unlock the screen of the mobile terminal.

Preferably, in the method for achieving screen unlocking of a mobile terminal through retina information matching, the step A specifically comprises:

A1. receiving an operation instruction by the mobile terminal to activate a retina unlocking mode;

A2. setting the first retina information for the retina unlocking mode; and

A3. receiving and storing the retina information.

Preferably, in the method for achieving screen unlocking of a mobile terminal through retina information matching, the step of communicatively connecting a retina reading device with the mobile terminal comprises:

communicatively connecting the mobile terminal with the retina reading device via the Near Field Communication (NFC) protocol, or

communicatively connecting the mobile terminal with the retina reading device via the Bluetooth (BT) protocol.

Preferably, in the method for achieving screen unlocking of a mobile terminal through retina information matching, the step C specifically comprises:

C10. taking a photo of the retina by the retina reading device to obtain a retina image;

C20. processing the retina image by the retina reading device to obtain the second retina information having retina features; and

C30. transmitting the second retina information to the mobile terminal.

Preferably, in the method for achieving screen unlocking of a mobile terminal through retina information matching, the step C specifically comprises:

C100, taking a photo of the retina by the retina reading device to obtain a retina image;

C200. transmitting the retina image to the mobile terminal; and

C300. processing the retina image by the mobile terminal to obtain the second retina information having retina features.

Preferably, in the method for achieving screen unlocking of a mobile terminal through retina information matching,

the mobile terminal may be connected with the retina reading device within a set distance, and the set distance is 1 m, 0.5 m, 0.3 m or 0.2 m.

Corresponding to the aforesaid method, the present disclosure further provides a system for achieving screen unlocking of a mobile terminal through retina information matching, which comprises:

a retina information storage module for storing first retina information for screen unlocking into the mobile terminal;

a communication module for communicatively connecting a retina reading device with the mobile terminal;

a retina reading and transmitting module for use by the retina reading device to read second retina information and transmit the second retina information to the mobile terminal;

a matching module for use by the mobile terminal to receive the second retina information and match the second retina information against the first retina information; and

an instruction generating and unlocking module for generating a screen unlocking instruction to unlock the screen of the mobile terminal if the second retina information matches the first retina information.

Preferably, in the system for achieving screen unlocking of a mobile terminal through retina information matching, the retina information storage module specifically comprises:

a mode activating module for use by the mobile terminal to receive an operation instruction to activate a retina unlocking mode;

a retina information setting module for setting the first retina information for the retina unlocking mode; and

a storage module for receiving and storing the retina information.

Preferably, in the system for achieving screen unlocking of a mobile terminal through retina information matching, the communication module comprises:

a first NFC communication module disposed in the mobile terminal and a second NFC communication module disposed in the retina reading device, or

a first BT communication module disposed in the mobile terminal and a second BT communication module disposed in the retina reading device.

Preferably, in the system for achieving screen unlocking of a mobile terminal through retina information matching, the retina reading and transmitting module specifically comprises:

a reading module for use by the retina reading device to take a photo of the retina to obtain a retina image;

a processing module for use by the retina reading device to process the retina image to obtain the second retina information having retina features; and

a transmitting module for transmitting the second retina information to the mobile terminal.

Preferably, in the system for achieving screen unlocking of a mobile terminal through retina information matching, the retina reading and transmitting module specifically comprises:

a reading module for use by the retina reading device to take a photo of the retina to obtain a retina image;

a transmitting module for transmitting the retina image to the mobile terminal; and

a processing module for use by the mobile terminal to process the retina image to obtain the second retina information having retina features.

Preferably, in the system for achieving screen unlocking of a mobile terminal through retina information matching,

the mobile terminal may be connected with the retina reading device within a set distance, and the set distance is 1 m, 0.5 m, 0.3 m or 0.2 m.

In the method and the system for achieving screen unlocking of a mobile terminal through retina information matching according to the present disclosure, the retina reading device reads retina information of the user and then transmits the retina information to the mobile terminal that is connected with the retina reading device so as to unlock the mobile terminal through matching. The need of device cooperation and retina information matching makes it more difficult to unlock the mobile terminal so that the personal information becomes more secure. The retina reading device of the present disclosure can be connected with the mobile terminal through induction as long as the retina reading device and the mobile terminal are within a set range with respect to each other. Thus, the user can unlock the mobile terminal simply by putting the mobile terminal in front of him/her, which is simple and convenient; and only the user itself can unlock the mobile terminal in this way.

### BRIEF DESCRIPTION OF THE DRAWINGS

FIG. 1 is a flowchart diagram of a method for achieving screen unlocking of a mobile terminal through retina information matching according to the present disclosure; and

FIG. 2 is a structural view of a system for achieving screen unlocking of a mobile terminal through retina information matching according to the present disclosure.

### DETAILED DESCRIPTION OF THE INVENTION

The present disclosure provides a method and a system for achieving screen unlocking of a mobile terminal through retina information matching. To make the objectives, technical solutions and effects of the present disclosure clearer and more definite, the present disclosure will be further detailed with reference to the attached drawings and examples hereinafter. It shall be appreciated that, the specific embodiments described herein are only for purpose of illustration rather than limitation.

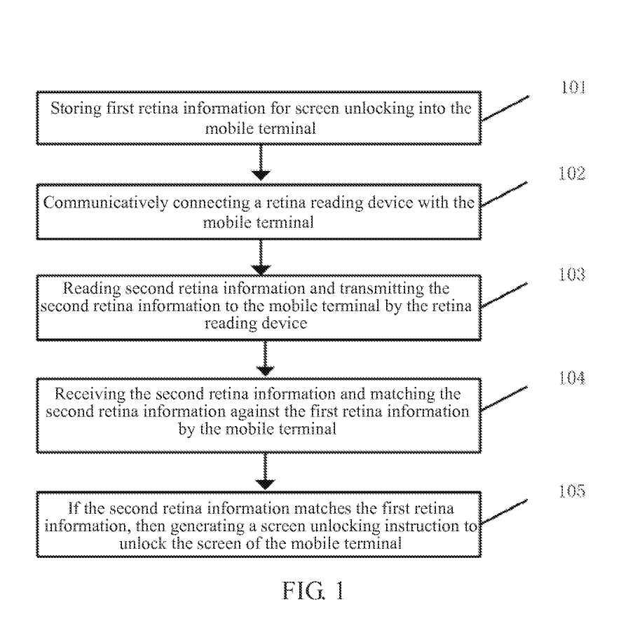

FIG. 1 is a flowchart diagram of a method for achieving screen unlocking of a mobile terminal through retina information matching according to the present disclosure. As shown in FIG. 1, the method for achieving screen unlocking of a mobile terminal through retina information matching comprises the follow steps.

101. storing first retina information for screen unlocking into the mobile terminal. Specifically, the mobile terminal described in the step 101 is a mobile phone and a tablet computer with the Android system, the Internetwork Operating System (IOS) system or the Windows Phone (WP) system, etc. In implementation of the present disclosure, the mobile terminal needs to be switched to a retina unlocking mode which is a kind of screen locking mode of the system of the mobile terminal. After the retina unlocking mode is activated, retina information (i.e., first retina information) of the user needs to be set for the retina unlocking mode during the first-time use. The first retina information is used for matching with the inputted retina information, and if the first retina information matches the inputted retina information, then the mobile terminal is unlocked. The first retina information can be stored in many ways. For example, a camera of the mobile terminal may be utilized to capture the retina of the user, or a retina reading device may be utilized to read the retina information of the user, and then the retina information of the user read by the retina reading device is transmitted and stored into the mobile terminal. The retina reading device mentioned herein refers to a wearable device, e.g., Google Glasses produced by Google, and thus the retina reading device can read the retina information of the user timely and conveniently. The retina reading device is provided with a communication module (i.e., a second communication module) and a reading module. The second communication module is used for communication with a first communication module disposed in the mobile terminal, and the reading module is for use by the retina reading device to take a photo of the retina to obtain a retina image.

102. communicatively connecting a retina reading device with the mobile terminal.

Specifically, the retina reading device described in the step 102 is provided with a second communication module, and the second communication module communicates with the first communication module disposed in the mobile terminal. Further, the first communication module is a first NFC communication module, and the second communication module is a second NFC communication module. NFC (Near Field Communication) refers to a short-distance high-frequency radio technology. The NFC technology works within a distance of 20 cm at a frequency of 1156 MHz, and the transmission speed thereof includes 106 Kbit/s, 212 Kbits and 424 Kbit/s. Currently, the NFC technology has been accepted by the ISO/IEC IS 18092 international standard, the ECMA-340 standard and the ETSI TS 102 190 standard. The NFC technology adopts both an active reading mode and a passive reading mode. The present disclosure adopts the NFC technology but does not adopt the aforesaid standards, and the NFC technology can be defined in the present disclosure. For example, the sensing distance of the NFC technology can be defined in such a way that the mobile terminal can be connected with the retina reading device if they are within a set distance from each other, and the set distance is 1 m, 0.5 m, 0.3 m or 0.2 m. The first communication module is a first BT communication module, and the second communication module is a second BT communication module. Both the first BT communication module and the second BT communication module are BT sensors. When the mobile terminal is in a standby state, the BT sensor firstly searches and determines whether there is a unique mobile terminal within a distance of 0.2 m to 1 m with a low-frequency signal; and if there is, then it is determined that there is a short distance between the BT sensor and the mobile terminal. If no mobile terminal has been found, then the BT sensor searches again with a high-frequency signal after 2 s, and in this case, it is determined that the distance between the BT sensor and the mobile terminal is greater than 1 m, i.e., there is a long distance between the BT sensor and the mobile terminal. During the aforesaid process, the retina reading device is automatically connected with the mobile terminal when there is induction therebetween.

103. reading second retina information and transmitting the second retina information to the mobile terminal by the retina reading device.

Specifically, in the step 103, the retina reading device reads the second retina information after the retina reading device is communicatively connected with the mobile terminal in the aforesaid step 102. Further, the retina reading device takes a photo of the retina to obtain a retina image, processes the retina image to obtain the second retina information having retina features, and transmits the second retina information to the mobile terminal. The retina reading device may also read the second retina information in the following step in the present disclosure: taking a photo of the retina by the retina reading device to obtain a retina image; transmitting the retina image to the mobile terminal; and processing the retina image by the mobile terminal to obtain the second retina information having retina features. The aforesaid two processes differ in the processing of the retina information. If the retina information is to be processed b the retina reading device, then different brands of retina reading devices may process the retina information in different procedures and thus generate different processing results for the same retina information. However, if the retina information is to be processed by the mobile terminal, then the retina reading device is only used to take a photo of the retina, and the captured retina image is then processed by the mobile terminal with the same procedure and the same algorithm to obtain the same result.

104. receiving the second retina information and matching the second retina information against the first retina information by the mobile terminal.

Specifically, in the step 104, the mobile terminal receives the second retina information transmitted by the retina reading device, or receives and processes the second retina image transmitted by the retina reading device to obtain the second retina information, and then matches the second retina information against the first retina information. This process is known in the prior art, and thus will not be further described herein.

105. if the second retina information matches the first retina information, then generating a screen unlocking instruction to unlock the screen of the mobile terminal.

Specifically in the step 105, if the second retina information matches the first retina information, then a screen unlocking instruction for the mobile terminal is generated, and the mobile terminal receives the unlocking instruction to unlock the screen. It shall be appreciated that, the method for achieving screen unlocking of a mobile terminal through retina information matching according to the present disclosure can coexist with other screen unlocking mechanisms. Thus, in cases where the user cannot use the retina information to unlock the screen for some reason, he/she can still use other unlocking mechanisms to unlock the screen, which will not influence the use of the mobile terminal.

In the method for achieving screen unlocking of a mobile terminal through retina information matching, the step A specifically comprises:

A1. receiving an operation instruction by the mobile terminal to activate a retina unlocking mode;

A2. setting the first retina information for the retina unlocking mode; and

A3. receiving and storing the retina information.

In the method for achieving screen unlocking of a mobile terminal through retina information matching, the step of communicatively connecting a retina reading device with the mobile terminal comprises:

communicatively connecting the mobile terminal with the retina reading device via the NFC protocol, or

communicatively connecting the mobile terminal with the retina reading device via the BT protocol.

In the method for achieving screen unlocking of a mobile terminal through retina information matching, the step C specifically comprises:

C10. taking a photo of the retina by the retina reading device to obtain a retina image;

C20. processing the retina image by the retina reading device to obtain the second retina information having retina features; and

C30. transmitting the second retina information to the mobile terminal.

In the method for achieving screen unlocking of a mobile terminal through retina information matching, the step C specifically comprises:

C100. taking a photo of the retina by the retina reading device to obtain a retina image;

C200. transmitting the retina image to the mobile terminal; and

C300. processing the retina image by the mobile terminal to obtain the second retina information having retina features.

In the method for achieving screen unlocking of a mobile terminal through retina information matching,

the mobile terminal can be connected with the retina reading device if they are within a set distance from each other, and the set distance is 1 m, 0.5 m, 0.3 m or 0.2 m. According to the technical solutions of the present disclosure, the set distance cannot be set too large. Specifically, the retina reading device described in the present disclosure is a wearable device (like a pair of glasses), while the mobile terminal described in the present disclosure is usually put in a pocket. If the pocket is a pants pocket, then the distance between the location of the pocket and the location of eyes of the user is about 60 cm; and if the pocket is a coat pocket, then the distance between the location of the pocket and the location of the eyes is about 30 cm. If the set distance is too large, then the mobile terminal will remain unlocked all the time. Generally speaking, the user unlocks the mobile terminal only when he/she uses the mobile terminal; that is, the distance between the mobile terminal and the eyes of the user is generally less than 30 cm when the mobile terminal is put in front of the user. Thus, the set distance between the mobile terminal and the retina reading device is preferably 0.3 cm in the present disclosure.

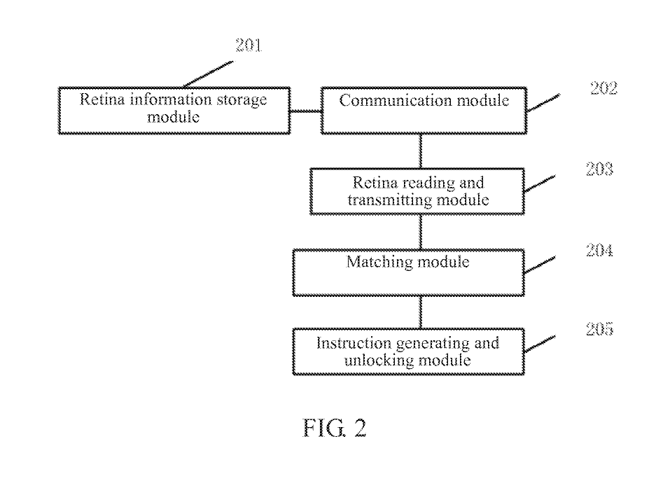

FIG. 2 is a structural view of a system for achieving screen unlocking of a mobile terminal through retina information matching according to the present disclosure. As shown in FIG. 2, the system for achieving screen unlocking of a mobile terminal through retina information matching according to the present disclosure comprises:

a retina information storage module 201, for storing first retina information for screen unlocking into the mobile terminal, specifically as described above;

a communication module 202 for communicatively connecting a retina reading device with the mobile terminal, specifically as described above;

a retina reading and transmitting module 203 for use by the retina reading device to read second retina information and transmit the second retina information to the mobile terminal, specifically as described above;

a matching module 204 for use by the mobile terminal to receive the second retina information and match the second retina information against the first retina information, specifically as described above; and

an instruction generating and unlocking module 205 for generating a screen unlocking instruction to unlock the screen of the mobile terminal if the second retina information matches the first retina information, specifically as described above.

In the system for achieving screen unlocking of a mobile terminal through retina information matching, the retina information storage module 201 specifically comprises:

a mode activating module for use by the mobile terminal to receive an operation instruction to activate a retina unlocking mode, specifically as described above;

a retina information setting module for setting the first retina information for the retina unlocking mode, specifically as described above; and

a storage module for receiving and storing the retina information, specifically as described above.

In the system for achieving screen unlocking of a mobile terminal through retina information matching, the communication module 202 comprises:

a first NFC communication module disposed in the mobile terminal and a second NFC communication module disposed in the retina reading device, specifically as described above, or

a first BT communication module disposed in the mobile terminal and a second BT communication module disposed in the retina reading device, specifically as described above.

In the system for achieving screen unlocking of a mobile terminal through retina information matching, the retina reading and transmitting module 203 specifically comprises:

a reading module for use by the retina reading device to take a photo of the retina to obtain a retina image, specifically as described above;

a processing module for use by the retina reading device to process the retina image to obtain the second retina information having retina features, specifically as described above; and

a transmitting module for transmitting the second retina information to the mobile terminal, specifically as described above.

In the system for achieving screen unlocking of a mobile terminal through retina information matching, the retina reading and transmitting module 203 specifically comprises:

a reading module for use by the retina reading device to take a photo of the retina to obtain a retina image, specifically as described above;

a transmitting module for transmitting the retina image to the mobile terminal, specifically as described above; and

a processing module for use by the mobile terminal to process the retina image to obtain the second retina information having retina features, specifically as described above.

In the system for achieving screen unlocking of a mobile terminal through retina information matching,

the mobile terminal can be connected with the retina reading device if they are within a set distance from each other, and the set distance is 1 m, 0.5 m, 0.3 m or 0.2 m, specifically as described above.

In the method and the system for achieving screen unlocking of a mobile terminal through retina information matching according to the present disclosure, the retina reading device reads retina information of the user and then transmits the retina information to the mobile terminal that is connected with the retina reading device so as to unlock the mobile terminal through matching. The need of device cooperation and retina information matching makes it more difficult to unlock the mobile terminal so that the personal information is more secure. The retina reading device of the present disclosure can be connected with the mobile terminal through induction as long as the retina reading device and the mobile terminal are within a set range with respect to each other. Thus, the user can unlock the mobile terminal simply by putting the mobile terminal in front of him/her, which is simple and convenient; and only the user itself can unlock the mobile terminal in this way.

What described above are only the embodiments of the present disclosure, but are not intended to limit the scope of the present disclosure. Any equivalent structures or equivalent process flow modifications that are made according to the specification and the attached drawings of the present disclosure, or any direct or indirect applications of the present disclosure in other related technical fields shall all be covered within the scope of the present disclosure.

1. A method for achieving screen unlocking of a mobile terminal through retina information matching, comprising the following steps of:
A. storing first retina information for screen unlocking into the mobile terminal;
B. communicatively connecting a retina reading device with the mobile terminal;
C. reading second retina information and transmitting the second retina information to the mobile terminal by the retina reading device;
D. receiving the second retina information and matching the second retina information against the first retina information by the mobile terminal; and
E. if the second retina information matches the first retina information, then generating a screen unlocking instruction to unlock the screen of the mobile terminal.

2. The method for achieving screen unlocking of a mobile terminal through retina information matching of claim 1, wherein the step of communicatively connecting a retina reading device with the mobile terminal comprises:
communicatively connecting the mobile terminal with the retina reading device via the Near Field Communication (NFC) protocol, or
communicatively connecting the mobile terminal with the retina reading device via the Bluetooth (BT) protocol.

3. The method for achieving screen unlocking of a mobile terminal through retina information matching of claim 1, wherein a communication distance between the retina reading device and the mobile terminal is 1 m, 0.5 m, 0.3 m or 0.2 m.

4. The method for achieving screen unlocking of a mobile terminal through retina information matching of claim 1, wherein the step C specifically comprises:
C10. taking a photo of the retina by the retina reading device to obtain a retina image;
C20. processing the retina image by the retina reading device to obtain the second retina information having retina features; and
C30. transmitting the second retina information to the mobile terminal.

5. The method for achieving screen unlocking of a mobile terminal through retina information matching of claim 1, wherein the step C specifically comprises:
C100. taking a photo of the retina by the retina reading device to obtain a retina image;
C200. transmitting the retina image to the mobile terminal; and
C300. processing the retina image by the mobile terminal to obtain the second retina information having retina features.

6. A method for achieving screen unlocking of a mobile terminal through retina information matching, comprising the following steps of:
A. storing first retina information for screen unlocking into the mobile terminal;
B. communicatively connecting a retina reading device with the mobile terminal;
C. reading second retina information and transmitting the second retina information to the mobile terminal by the retina reading device;
D. receiving the second retina information and matching the second retina information against the first retina information by the mobile terminal; and
E. if the second retina information matches the first retina information, then generating a screen unlocking instruction to unlock the screen of the mobile terminal;
wherein the step A specifically comprises:
A1. receiving an operation instruction by the mobile terminal to activate a retina unlocking mode;
A2. setting the first retina information for the retina unlocking mode; and
A3. receiving and storing the retina information.

7. The method for achieving screen unlocking of a mobile terminal through retina information matching of claim 6, wherein the step of communicatively connecting a retina reading device with the mobile terminal comprises:
communicatively connecting the mobile terminal with the retina reading device via the NFC protocol, or
communicatively connecting the mobile terminal with the retina reading device via the BT protocol.

8. The method for achieving screen unlocking of a mobile terminal through retina information matching of claim 6, wherein a communication distance between the retina reading device and the mobile terminal is 1 m, 0.5 m, 0.3 m or 0.2 m.

9. The method for achieving screen unlocking of a mobile terminal through retina information matching of claim 6, wherein the step C specifically comprises:
C10. taking a photo of the retina by the retina reading device to obtain a retina image;
C20. processing the retina image by the retina reading device to obtain the second retina information having retina features; and
C30. transmitting the second retina information to the mobile terminal.

10. The method for achieving screen unlocking of a mobile terminal through retina information matching of claim 6, wherein the step C specifically comprises:
C100. taking a photo of the retina by the retina reading device to obtain a retina image;
C200. transmitting the retina image to the mobile terminal; and
C300. processing the retina image by the mobile terminal to obtain the second retina information having retina features.

11. A system for achieving screen unlocking of a mobile terminal through retina information matching, comprising:
a retina information storage module for storing first retina information for screen unlocking into the mobile terminal;
a communication module for communicatively connecting a retina reading device with the mobile terminal;
a retina reading and transmitting module for use by the retina reading device to read second retina information and transmit the second retina information to the mobile terminal;
a matching module for use by the mobile terminal to receive the second retina information and match the second retina information against the first retina information; and
an instruction generating and unlocking module for generating a screen unlocking instruction to unlock the screen of the mobile terminal if the second retina information matches the first retina information.

12. The system for achieving screen unlocking of a mobile terminal through retina information matching of claim 11, wherein the retina information storage module specifically comprises:
a mode activating module for use by the mobile terminal to receive an operation instruction to activate a retina unlocking mode;
a retina information setting module for setting the first retina information for the retina unlocking mode; and
a storage module for receiving and storing the retina information.

13. The system for achieving screen unlocking of a mobile terminal through retina information matching of claim 11, wherein the communication module comprises:
a first NFC communication module disposed in the mobile terminal and a second NFC communication module disposed in the retina reading device, or
a first BT communication module disposed in the mobile terminal and a second BT communication module disposed in the retina reading device.

14. The system for achieving screen unlocking of a mobile terminal through retina information matching of claim 11, wherein the retina reading and transmitting module specifically comprises:
a reading module for use by the retina reading device to take a photo of the retina to obtain a retina image;
a processing module for use by the retina reading device to process the retina image to obtain the second retina information having retina features; and
a transmitting module for transmitting the second retina information to the mobile terminal.

15. The system for achieving screen unlocking of a mobile terminal through retina information matching of claim 11, wherein the retina reading and transmitting module specifically comprises:
a reading module for use by the retina reading device to take a photo of the retina to obtain a retina image;
a transmitting module for transmitting the retina image to the mobile terminal; and
a processing module for use by the mobile terminal to process the retina image to obtain the second retina information having retina features.

16. The method for achieving screen unlocking of a mobile terminal through retina information matching of claim 1, wherein the step of storing first retina information for screen unlocking into the mobile terminal comprises:
capturing the first retina information by a camera of the mobile terminal; and
storing the captured first retina information into the mobile terminal.

17. The method for achieving screen unlocking of a mobile terminal through retina information matching of claim 1, wherein the step of storing first retina information for screen unlocking into the mobile terminal comprises:
reading the first retina information by the retina reading device; and
transmitting the first retina information from the retina reading device to the mobile terminal and storing the first retina information into the mobile terminal.

18. The method for achieving screen unlocking, of a mobile terminal through retina information matching of claim 1, wherein the retina reading device is wearable device.

19. The method for achieving screen unlocking of a mobile terminal through retina information matching of claim 1, wherein the method for achieving screen unlocking of a mobile terminal through retina information matching cooperates with other screen unlocking mechanisms.
